(19) United States
(12) Patent Application Publication
(10) Pub. No.: US 2010/0149098 A1
(43) Pub. Date: Jun. 17, 2010

(54) Apparatus and method of providing an apparatus

(75) Inventors: Harri A. Lasarov, Espoo (FI); Pekka J. Pihlaja, Hevonpaa (FI)

Correspondence Address: HARRINGTON & SMITH, 4 RESEARCH DRIVE, Suite 202, SHELTON, CT, 06484-6212, US

(73) Assignee: Nokia Corporation

(21) Appl. No.: 12/316,619

(22) Filed: Dec. 15, 2008

(51) Int. Cl. G06F 3/02

(52) U.S. Cl. 345/168

(57) ABSTRACT

An apparatus and method of providing an apparatus, the apparatus including: a display including a plurality of layers including a display layer and a first protective layer overlaying the display layer wherein the display layer includes at least one discontinuity and the protective layer is continuous over the discontinuity in the display layer; and a user input portion associated with the area of the first protective layer overlaying the discontinuity in the display layer and configured such that actuation of the user input portion enables a switch to be actuated.

### FIELD OF THE INVENTION

Embodiments of the present invention relate to an apparatus and method of providing an apparatus. In particular, they relate to an apparatus and method of providing an apparatus where the apparatus comprises a display and a user input device.

### BACKGROUND TO THE INVENTION

Electronic apparatus are well known. It is also well known for electronic apparatus to be configured to perform a plurality of different functions. For example an apparatus may be configured to be operable as a cellular telephone, a digital camera and also a personal music player. Such apparatus need a user input device such as a keypad which can be used to enable access to each of the functions.

In apparatus where the available user input devices are limited, for example, in a handheld apparatus, it may be useful to enable a plurality of functions to be associated with any one user input mechanism of the user input device. It is useful to enable a user to clearly identify which functions are associated with each mechanism of the user input device.

### BRIEF DESCRIPTION OF VARIOUS EMBODIMENTS OF THE INVENTION

According to various, but not necessarily all, embodiments of the invention there is provided an apparatus comprising: a display comprising a plurality of layers including a display layer and a first protective layer overlaying the display layer wherein the display layer comprises at least one discontinuity and the protective layer is continuous over the discontinuity in the display layer; and a user input portion associated with the area of the first protective layer overlaying the discontinuity in the display layer and configured such that actuation of the user input portion enables a switch to be actuated.

In some embodiments of the invention the switch may be located beneath the discontinuity in the display layer.

In some embodiments of the invention the display layer may comprise a plurality of discontinuities and the first protective layer may be continuous over the plurality of discontinuities in the display layer.

In some embodiments of the invention the user input portion may be a key portion coupled to the first protective layer.

In some embodiments of the invention the first protective layer may be configured to deform when the user input portion is actuated.

In some embodiments of the invention the apparatus may comprise a second protective layer underneath the display layer wherein the second protective layer is continuous under the discontinuity in the display layer. The apparatus may also comprise an actuating portion, associated with the area of the second protective layer underneath the discontinuities in the display layer, and configured to actuate a switch when the user input portion is actuated. The second protective layer may be configured to deform when the user input portion is actuated.

In some embodiments of the invention the first protective layer may be transparent so that the display layer is visible through the first protective layer.

In some embodiments of the invention the display layer may be configured to display information adjacent to the user input portion indicative of a function associated with the user input portion. The orientation of the information displayed on the display may depend upon the orientation of the apparatus.

In some embodiments of the invention the apparatus may comprise a transparent layer overlaying the first protective layer wherein the transparent layer may be rigid relative to the first protective layer and may comprise discontinuities in the areas overlaying the user input portions.

In some embodiments of the invention the display layer may comprise a plurality of layers including at least one electrode layer and an electronic ink layer.

According to various, but not necessarily all, embodiments of the invention there is provided a method comprising: providing a display comprising a plurality of layers including a display layer and a first protective layer overlaying the display layer wherein the display layer comprises at least one discontinuity and the protective layer is continuous over the discontinuity in the display layer; and providing a user input portion associated with the area of the first protective layer overlaying the discontinuity in the display layer and configured such that actuation of the user input portion enables a switch to be actuated.

The apparatus may be for wireless communication.

### BRIEF DESCRIPTION OF THE DRAWINGS

For a better understanding of various examples of embodiments of the present invention reference will now be made by way of example only to the accompanying drawings in which:

FIG. 1 illustrates an apparatus according to a first embodiment of the invention;

FIG. 2 is a cross section of the apparatus illustrated in FIG. 1;

FIG. 3 illustrates a cross section through the display according to the first embodiment of the invention at a first location;

FIG. 4 illustrates a cross section through the display according to the first embodiment of the invention at a second location;

FIG. 5 illustrates an apparatus according to a second embodiment of the invention; and

FIG. 6 is a cross section of the apparatus illustrated in FIG. 5.

### DETAILED DESCRIPTION OF VARIOUS EMBODIMENTS OF THE INVENTION

The Figures illustrate an apparatus 10 comprising: a display 16 comprising a plurality of layers including a display layer 34 and a first protective layer 32 overlaying the display layer 34 wherein the display layer 34 comprises at least one discontinuity 60 and the protective layer 32 is continuous over the discontinuity 60 in the display layer 34; and a user input portion 18 associated with the area of the first protective layer 32 overlaying the discontinuity 60 in the display layer 34 and configured such that actuation of the user input portion 18 enables a switch 40 to be actuated.

In the following description, unless expressly stated otherwise, the words “connect” and “couple” and their derivatives mean operationally connected or operationally coupled. It is to be appreciated that any number or combination of intervening components can exist including no intervening components.

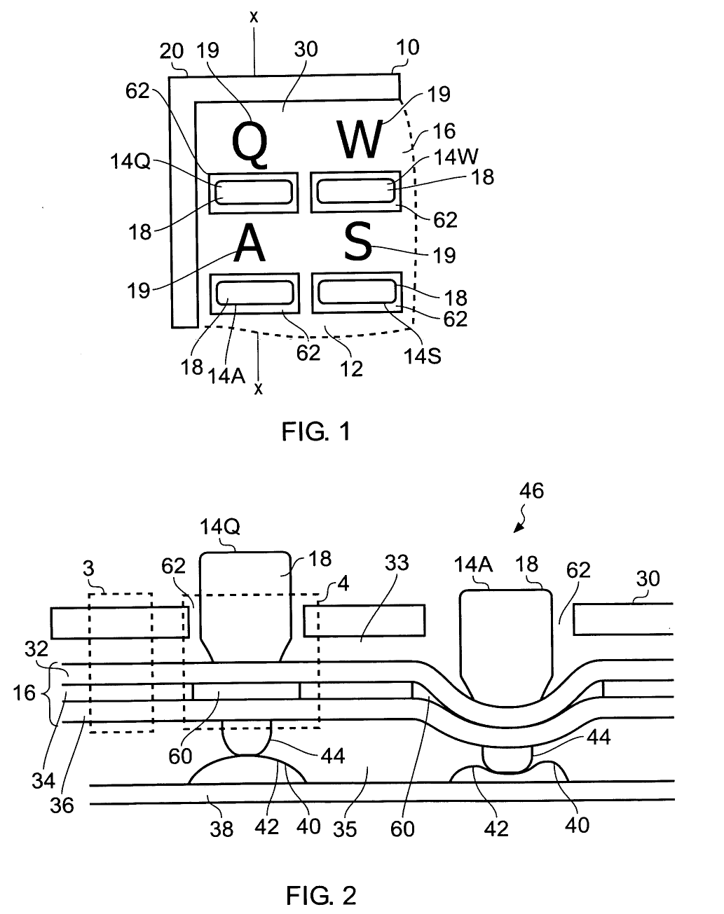

FIG. 1 illustrates a section of an apparatus 10 according to an embodiment of the invention. The apparatus 10 may be an electronic apparatus. Only features referred to in the following description are illustrated. It should, however, be understood that the apparatus 10 may comprise additional features that are not illustrated. The apparatus 10 may be, for example, a mobile cellular telephone, a personal computer, a camera, a personal digital assistant or any other apparatus that comprises a user input device which enables a user to input information. The apparatus 10 may be a handheld apparatus 10 which can be carried in a user's hand, handbag or jacket pocket for example.

The apparatus 10 comprises a display 16 and a keypad 12 comprising a plurality of keys 14.

FIG. 1 only illustrates a section of the apparatus 10. In FIG. 1 only four keys 14 are illustrated. It is to be appreciated that any number of keys 14 may be provided on the apparatus 10. The keys 14 may be arranged in any configuration. For example, the keys 14 may be arranged in rows corresponding to a qwerty keypad or the keys 14 may be arranged in four rows each comprising three keys 14 corresponding to an ITU-T (International telecommunication union telecommunications body) keypad.

In some embodiments of the invention only a single key 14 may be provided. The single key may 14 be a multi-direction input device such as a joystick or a rocker or roller key.

The keys 14 provide a user input portion 18 and may be any user input mechanism which enables a user to close a switch. In the illustrated embodiment each key 14 comprises a user input portion 18 which is located on the front of the apparatus 10 and is configured to be actuated by a user. The remainder of the key mechanism is positioned beneath the user input portion 18 and underneath the display 16 and is not visible in FIG. 1.

The display 16 is configured to display information to a user. In the illustrated embodiment the display 16 is configured so that the keypad 12 is integrated within the display 16. A portion of the display 16 is located adjacent to each of the user input portions 18 and is configured to display information indicative of a function associated with the key 14 corresponding to the adjacent user input portion 18.

In the illustrated embodiment the information indicative of the function of the key 14 is displayed above the user input portion 18. In other embodiments of the invention it may be displayed beneath the user input portion 18 or to the side of the user input portion 18.

In the illustrated embodiment the information displayed on the display 16 are letters 19. Each key 14 has a single letter 19 associated with it. This indicates that actuating the user input portion 18 adjacent to the displayed letter 19 will enable the displayed letter 19 to be input into the apparatus 10. This enables a user to input text into the apparatus 10. It is to be appreciated that any function may be associated with the keys 14, for example, the keys 14 may be associated with other alphanumeric characters such as numbers which may enable information to be input into the apparatus 10. The keys 14 may also be associated with functions of the apparatus 10 such that actuation of the user input portion 18 enables access to an application or a specific function of the apparatus 10.

The function associated with any key 14 may be dependent upon the mode of operation of the apparatus 10. The display 16 may be configured to display different information corresponding to the mode of operation of the apparatus 10.

Also the apparatus 10 may have different orientations. For example the apparatus may be operable in both a landscape orientation and a portrait orientation. The display 16 may be configured so that the orientation of the information displayed on the display 16 corresponds to the orientation of the apparatus 10.

The display 16 comprises a seal portion 20. The seal portion 20 extends around the perimeter of the display 16 and forms a hermetic seal to protect the electronic components of the display 16 from damage. The seal portion 20 may protect the electronic components of the display 16 from damage due to fluid ingress.

A window 30 is provided overlying the display 16. The window 30 is transparent such that the display 16 is visible through the window 30.

The window 30 may be rigid relative to the display 16. The window 30 may protect the display 16 from damage, for example it may protect the display 16 from being scratched or from being damaged by a mechanical shock. The window 30 may be made of any suitable material such as glass or a thermoplastic such as polymethylmethacrylate (PMMA).

The window 30 comprises discontinuities 62. The window 30 may comprise a plurality of discontinuities 62. In the illustrated embodiment the window 30 may comprise a discontinuity 62 for each of the keys 14 of the keypad 12.

In the illustrated embodiments the discontinuities 62 of the window 30 comprise gaps. The user input portions 18 of the keys 14 extend through the gaps. In the illustrated embodiment the gaps are rectangular shaped and are sized such that the user input portions 18 can move in a vertical direction through the gaps.

FIG. 2 is a cross section of the apparatus illustrated in FIG. 1 along the line X-X. The layers of the display 16 and the components of the key 14 which are positioned underneath the display 16 are illustrated in FIG. 2.

The window 30 overlays the display 16. In the illustrated embodiment the window 30 is substantially flat. In other embodiments of the invention the window 30 may not be flat, for example, the window 30 may be curved so that the window is not located in a plane parallel to the display 16. The window 30 may define an outer surface of the apparatus 10. The window 30 may form part of a housing of the apparatus 10.

The window 30 may have a thickness of approximately 0.3-0.8 mm.

The display 16 is provided underlying the window 30. In the illustrated embodiment a gap 33 is provided between the display 16 and the window 30. In other embodiments the window 30 may overlay the display 16 so that the window 30 is in physical contact with the display 16.

The display 16 comprises a plurality of layers. In the illustrated embodiment the display 16 comprises a first protective layer 32, a display layer 34 and a second protective layer 36.

The first protective layer 32 is provided underlying the window 30 and overlying the display layer 34 and the second protective layer 36.

The first protective layer 32 may be flexible relative to the window 30. The first protective layer 32 may be flexible enough to be deformed when the user input portion 18 is actuated by a user.

The first protective layer 32 may be transparent so that the display layer 34 is visible through the first protective layer 32.

The first protective layer 32 may be made of any suitable material such as a flexible thermoplastic. The first protective layer 32 may have a thickness of approximately 0.01-0.2 mm.

The first protective layer 32 is continuous underneath the discontinuities 62 of the window 30 so that the first protective layer 32 forms an unbroken surface between the window 30 and the display layer 34.

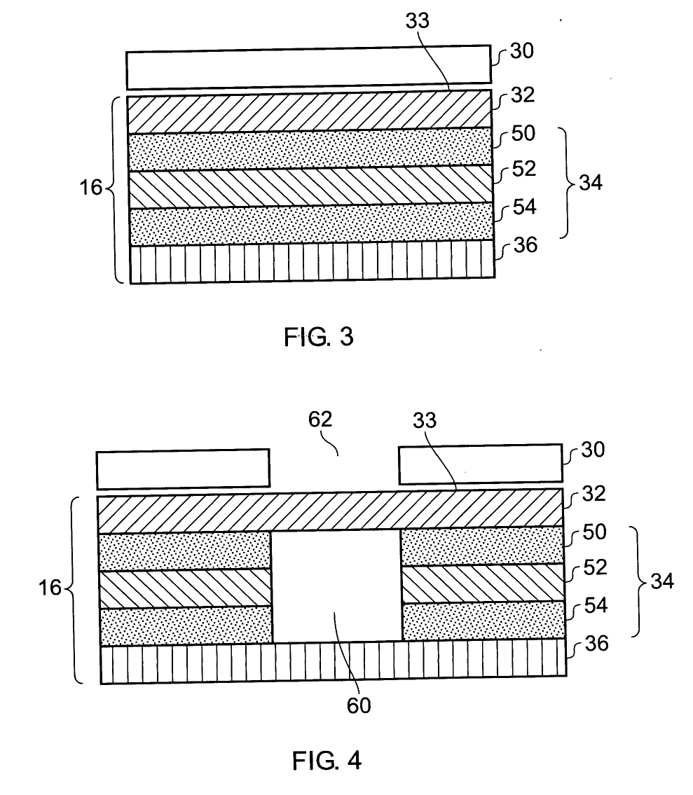

The display layer 34 is provided underneath the first protective layer 32. The display layer 34 itself may comprise a further plurality of layers. An example of a display layer 34 according to an embodiment of the invention is illustrated in more detail in FIGS. 3 and 4.

The display layer 34 may be any suitable type of display. In the illustrated embodiment the display layer 34 is an electrophoretic display comprising charged pigment particles which are suspended in a fluid and configured to move in response to an applied electric field. The display layer 34 may comprise an electronic paper display. In other embodiments of the invention the display layer 34 may comprise a layer comprising an LCD (liquid crystal display) or an OLED (organic light emitting diode) layer or any bi-stable flexible display such as a cholesteric LCD layer or any other suitable type of display.

The display layer 34 comprises discontinuities 60. The display layer 34 may comprise a plurality of discontinuities 60. In the illustrated embodiment the display layer 34 may comprise a discontinuity 60 for each of the keys 14 of the keypad 12.

The discontinuities 60 of the display layer 34 are located underneath the discontinuities 62 of the window 30 so that the discontinuities 60 of the display layer 34 are aligned vertically with the discontinuities 62 of the window 30. The discontinuities 60 of the display layer 34 may be approximately the same shape and size as the discontinuities 62 of the window 30.

The second protective layer 36 is provided underlying the display layer 34. The second protective layer 36 is continuous underneath both the discontinuities 62 of the window 30 and the discontinuities of the display layer 34 so that the second protective layer 36 forms an unbroken layer underneath the display layer 34.

The second protective layer 36 may also be flexible enough to be deformed when the key 14 is actuated by a user.

The second protective layer 36 may be made any of suitable material such as a flexible thermoplastic or a metal foil such as aluminum. The second protective layer 36 may have a thickness of approximately 0.01-0.2 mm.

The first protective layer 32, the display layer 34 and the second protective layer 36 may be bonded together.

A printed circuit board 38 is provided underlying the second protective layer 36. A gap 35 is provided between the second protective layer 36 and the printed circuit board 38. The functional circuitry which controls the apparatus 10 may be mounted on the printed circuit board 38.

Two keys 14 are illustrated in FIG. 2. The first key 14Q is illustrated in the rest state in which it has not been actuated. The keys 14 will remain in the rest state until the user input portion 18 is actuated by being pushed by a user. The second key 14A is illustrated in an actuated state in which the user input portion 18 has been pushed downwards by the user. The key 14A will remain in the actuated state until the pressure applied to the user input portion 18 is removed. Once the pressure applied to the user input portion 18 has been removed the key 14A will return to the idle state.

In the illustrated embodiment the keys 14 comprise user input portions 18 and actuating portions 44. The user input portion 18 is coupled to the first protective layer 32. In the illustrated embodiment the user input portion 18 is coupled to the first protective layer 32 by being adhered to the first protective layer 32.

The user input portion 18 is coupled to the first protective layer 32 in the area of the first protective layer 32 overlaying the discontinuity 60 of the display layer 34. As the discontinuities 60 of the display layer 34 are aligned vertically with the discontinuities 62 of the window 30 the user input portion 18 projects upwards from the first protective layer 32 through the discontinuity 62 in the window 30 so that the first key portion 31 extends outwards from the window 30.

The actuating portion 44 of the key 14 is coupled to the second protective layer 36. In the illustrated embodiment the actuating portion 44 is adhered to the second protective layer 36 in the area of the second protective layer 36 which is positioned directly underneath the discontinuity 60 in the display layer 34. The user input portion 18 and the actuating portion 44 are vertically aligned so that the actuating portion 42 is positioned directly underneath the user input portion 18.

The actuating portion 44 projects downwards from second protective layer 36 towards the printed circuit board 38 in the opposite direction to the user input portion 18.

A switch 40 is provided directly beneath the actuating portion 44. The switch may be any means which enables the apparatus to be changed from a first state to a second state. For example the switch 40 may be any means which enables an electric circuit to be completed in response to actuation of the user input portion 18. In the illustrated embodiment the switch 40 is a mechanical switch. It is to be appreciated that other types of switch 40 may be used, for example the switch 40 may comprise an optical sensor or a capacitive sensor or means for detecting an image such as a camera.

In the illustrated embodiment the switch 40 comprises a dome 42 which is configured to be deformed when the user input portion 18 is actuated. The dome 42 comprises a conductive portion which is configured so that when the dome 42 is deformed the conductive portion contacts the surface of the printed circuit board 38 and an electronic circuit is completed.

When the key 14 is in the idle state, as illustrated by the first key 14Q, the user input portion 18 of the key 14Q extends outwards from the window 30. The actuating portion 44 is coupled to the dome 42. In the illustrated embodiment the actuating portion 44 abuts the top of the dome 42. The dome 42 is not deformed when the key 14Q is in the idle state and the conductive portion of the dome 42 is not contacting the surface of the printed circuit board 38. In the illustrated embodiment the second protective layer 36 is substantially flat when the key 14Q is in the idle state.

When the key 14 is in the actuated state, as illustrated by the second key 14A, the user input portion 18 of the key 14A has been pushed downwards by a user in the direction indicated by the arrow 46. The user input portion 18 still extends out of the window 30 but not for as far as when the key 14 is in the idle state. The downwards motion of the user input portion 18 has deformed the first protective layer 32 in the area where the user input portion 18 is located so that the first protective layer 32 has also moved downwards into the discontinuity 60 in the display layer 34.

The downwards motion of the user input portion 18 and the first protective layer 32 has also deformed the second protective layer 36 in the area underlying the discontinuity 60 in the display layer 34 so that the second protective layer 36 has also moved downwards. As the second protective layer 36 has been moved downwards, this has also caused the actuating portion 44 to move downwards. This downwards motion of the actuating portion 44 has caused the dome 42 to be deformed and enabled an electrical circuit to be completed. The deformation of the dome 42 provides tactile feedback to a user to confirm that the actuation of the key 14 has been completed.

FIG. 3 illustrates a more detailed cross section through a portion of the display 16 according to the first embodiment of the invention. The portion of the display 16 illustrated in FIG. 3 corresponds to the area indicated by the number 3 in FIG. 2. This portion corresponds to an area of the display 16 in which information is displayed.

The cross section illustrated in FIG. 3 comprises a display 16 comprising an upper protection layer 32, a display layer 34, a lower protection layer 36 and a window 30 overlying the display 16 as illustrated in FIG. 2. The display layer 34 comprises a further plurality of layers 50, 52, 54.

All of the layers 32, 34 and 36 and the window 30 are continuous in the area where the information is displayed.

The display layer 34 comprises an upper electrode layer 50, a lower electrode layer 54 and an electronic ink layer 52. The upper electrode layer is bonded to the first protective layer 32. The lower electrode layer 34 is bonded to the second protective layer 34 and the electronic ink layer 52 is provided between the two electrode layers 50 and 54. The electronic ink layer 52 may have a thickness of approximately 0.01 to 0.2 mm. Each of the electrode layers 50, 54 may also have a thickness of approximately 0.01 to 0.2 mm.

The electronic ink layer 52 comprises charged pigment particles which are suspended in a fluid and configured to move in response to an applied electric field. The two electrode layers 50 and 54 are configured to apply an electric field to the electronic ink layer 52 to enable the electronic ink layer 52 to display information. The upper electrode layer 50 may be transparent so that the electronic ink layer 52 is visible through the upper electrode layer 50.

FIG. 4 also illustrates a more detailed cross section through the display 16 according to the first embodiment. The cross section of the display 16 illustrated in FIG. 4 illustrates the same level of detail as the cross section of FIG. 3. However the cross section of FIG. 4 corresponds to the portion indicated by the number 4 in FIG. 2. This portion corresponds to the area in which the key 14 is provided. The key 14 has not been illustrated in FIG. 4 for clarity.

As in FIG. 3 the section of the display 16 illustrated in FIG. 4 comprises an upper protection layer 32, a display layer 34 and a lower protection layer 36 and a window 30 overlying the display 16. The display layer 34 also comprises an upper electrode layer 50, a lower electrode layer 54 and an electronic ink layer 52.

However, in FIG. 4 the display layer 34 comprises a discontinuity 60. There is a discontinuity in each of the layers, 50, 52, 54 of the display layer 34 so that the discontinuity 60 is a discontinuity 60 through the entire depth of the display layer 34.

In other embodiments of the invention the discontinuity 60 may only extend through some of the layers 50, 52, 54 of the display layer 34. For example the discontinuity 60 may extend through the electronic ink layer 52 but not through the electrode layers 50, 54 so that the electrode layers 50, 54 are continuous over the discontinuity 60.

The window 30 also comprises a discontinuity 62. The discontinuity 62 of the window 30 is vertically aligned with the discontinuity 60 of the display layer so that the discontinuity 60 of the display layer is directly below the discontinuity 62 of the window 30.

In the embodiment illustrated in FIG. 4 the discontinuity in the display layer is a gap. That is, there is a space provided between the portions of the display layer 34. In other embodiments the discontinuity 60 may comprise a filler material. The filler material may be flexible so that it can be deformed when the key 14 is actuated.

Embodiments of the invention as described above provide the advantage that a display 16 can be integrated with a key pad 12 so that information may be displayed adjacent to the user input portion 18 of the keys 14 of the keypad 12. As this information is presented on a display 16 rather than on the user input portion 18 of the key 14 itself the information may be updated in dependence upon the mode or the orientation of the apparatus 10.

The first protective layer 32 which is continuous over the display layer 34 protects the display layer 34 from damage due to fluid ingress. As the first protective layer 32 is continuous there is no need to provide any additional seal portions in the area surrounding the keys 14 or the discontinuities in the window 32. This enables a relatively large portion of the display 16 to be used to display information adjacent to the key 14.

The second protective layer 36 is also continuous and also protects the display layer 34 without reducing the area of the display 16 available to display information.

The discontinuities in the display layer 34 enable the keys 14 to be actuated more easily as there is no additional resistance to the movement of the user input portion 18 from the display layer 34. This also protects the display layer 34 from being damaged as a result of being deformed many times.

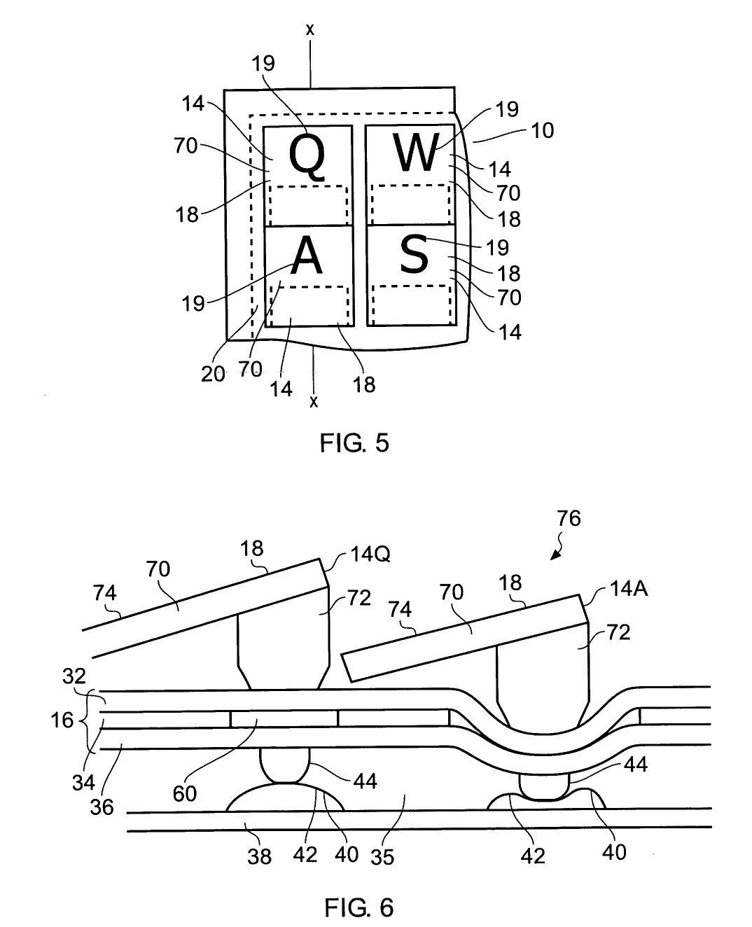

FIGS. 5 and 6 illustrate an apparatus 10 according to a second embodiment of the invention. In this embodiment of the invention the layers of the display 16 are the same as illustrated and described in the previous embodiment, however the keys 14 and the windows 30 have a different configuration.

FIG. 5 illustrates a portion of the apparatus 10 similar to the portion illustrated in FIG. 1. As in FIG. 1 the apparatus 10 comprises a display 16 and a keypad 12 comprising a plurality of keys 14.

Only four keys 14 are illustrated in FIG. 5. It is to be appreciated that any number of keys 14 may be provided and the keys 14 may be arranged in any configuration. For example, the keys 14 may be arranged in rows corresponding to a qwerty keypad or the keys 14 may be arranged in four rows each comprising three keys corresponding to an ITU-T (International telecommunication union telecommunications body) keypad.

The keys 14 provide a user input portion 18 and may be any user input device which enables a user to close a switch. In the illustrated embodiment each key 14 comprises a user input portion 18 which is located on the front of the apparatus and is configured to be actuated by a user. The remainder of the key mechanism is positioned beneath the user input portion 18 and the display 16 and is not visible in FIG. 1.

In the embodiment illustrated in FIG. 5 the user input portion 18 comprises an upper portion 70 and a lower portion 72. In the illustrated embodiment the upper portion 70 is substantially rectangular. The upper portion 70 extends over the area of the display 16 in which information is presented. The upper portion 70 is transparent so that the information presented on the display is visible through the window portion 70.

The lower portion 72 is coupled to the upper portion 70. The lower portion 72 is located underneath the upper portion 70 and is indicated by dashed lines in FIG. 5. In the illustrated embodiment the lower portion 72 is located along an edge of the upper portion 70.

As in the previously described embodiments the display 16 is configured to display information to a user. In the embodiment illustrated in FIG. 5 the display 16 is configured so that the keypad 12 is integrated within the display 16. A portion of the display 16 is located underneath the upper portion 70 and adjacent the lower portion 72 of the user input portion 18. The portion of the display 16 located underneath the upper portion 70 is configured to display information indicative of a function associated with the key corresponding to the overlaying user input portion 18.

In the embodiment illustrated in FIG. 5 the information displayed on the display 16 are letters 19.

The display 16 also comprises a seal portion 20 which extends around the perimeter of the display 16 and forms a hermetic seal to protect the electronic components of the display 16 from damage. The seal portion 20 may protect the electronic components of the display 16 from damage due to fluid ingress.

FIG. 6 is a cross section of the apparatus 10 illustrated in FIG. 5 along the line X-X. The apparatus 10 comprises a display 16 comprising a first protective layer 32, a display layer 34, a second protective layer 36 and a printed circuit board 38 as in the previous embodiments. The display layer 34 also comprises a discontinuity 60. The first protective layer 32 is continuous over the discontinuity 60 in the display layer 60 and the second protective layer 36 is continuous underneath the discontinuity 60 in the display layer 34. The actuation portion 44 of the key 14 and the switch 40 are the same as in the previously described embodiment.

Only two keys 14 are illustrated in 6. The first key 14Q is illustrated in the rest state in which it has not been actuated. The keys 14 will remain in the rest state until the user input portion 18 is actuated by being pushed by a user. The second key 14A is illustrated in an actuated state in which the user input portion 18 has been pushed downwards by the user. The key 14A will remain in the actuated state until the pressure applied to user input portion 18 is removed. Once the pressure applied to the user input portion 18 has been removed the key 14A will return to the idle state.

In the embodiment illustrated in FIG. 6 the keys 14 comprise user input portions 18 and actuation portions 44. As described in relation to FIG. 5 the user input portion 18 comprises an upper portion 70 and a lower portion 72.

The upper portion 70 is comprises a substantially flat surface layer 74. The substantially flat surface layer 74 is positioned at an angle relative to the display 16 so that the surface layer 74 of the upper portion 70 and the display 16 are not located in parallel planes to each other. In other embodiments of the invention the surface layer of the upper portion 70 may be positioned so that it is in a plane parallel to the display 16. In other embodiments the surface layer 74 may not be flat, for example, the surface layer 74 may be grooved to correspond to the shape of the finger of a user.

The upper portion 70 overlays the area of the display 16 in which the information indicative of the function of the key 14 is displayed. The upper portion 70 is transparent so that the information displayed on the display 16 is visible through the upper portion 70. The upper portion 70 may be rigid relative to the first protective layer 32 so that when it is pressed by a user it does not deform significantly.

The lower portion 72 is coupled to the upper portion 70 so that when the upper portion 70 is moved downwards the lower portion 72 also moves. The lower portion 72 is coupled to the underside of the lower portion 72. The lower portion 70 may be adhered to the upper portion 70.

The lower portion 72 is coupled to the first protective layer 32. The lower portion 72 may be coupled to the first protective layer 32 by an adhesive. The lower portion 72 is coupled to the first protective layer 32 in the area of the first protective layer 32 overlaying the discontinuity 60 of the display layer 34.

The actuating portion 44 is coupled to the second protective layer 36 and is not visible during normal use of the apparatus 10. In the illustrated embodiment the actuating portion 44 is adhered to the second protective layer 36 in the area of the second protective layer 36 which is positioned directly underneath the discontinuity 60 in the display layer 34. The actuating portion 44 and the lower portion 72 of the user input portion 18 are aligned vertically so that the actuating portion 44 is positioned directly underneath the lower portion 72 of the user input portion 18.

When the key 14 is in the idle state, as illustrated by the first key 14Q, the lower portion 72 of the user input portion 18 extends out of the surface of the first protective layer 32. The actuating portion 44 abuts the top of the dome 42. The dome 42 is not deformed when the key 14Q is in the idle state. In the illustrated embodiment the second protective layer 36 is substantially flat when the key 14Q is in the idle state.

When the key 14 is in the actuated state, as illustrated by the second key 14A, the upper portion 70 of the user input portion 18 has been pushed downwards by a user in the direction indicated by the arrow 76. This has caused the lower portion 72 which is coupled to the upper portion 70 to also be pushed downwards. The downwards motion of the lower portion 72 has deformed the first protective layer 32 in the area where the user input portion 18 is located so that the first protective layer 32 has also moved downwards in to the discontinuity 60 of the display layer 34.

The downwards motion of the user input portion 18 and the first protective layer 32 has also deformed the second protective layer 36 in the area underlying the discontinuity 60 in the display layer 34 so that the second protective layer 36 has also moved downwards. As the second protective layer 36 has been moved downwards, this has also caused the actuating portion 44 to move downwards which caused the dome 42 to be deformed and enabled an electrical circuit to be completed. The deformation of the dome 42 provides tactile feedback to a user to confirm that the actuation has been completed.

The upper portion 70 which provides part of the user input portion 18 provides the advantage that it provides a relatively large area for the user to actuate which makes the apparatus 10 easier for a user to use. Having a part of the user input portion 18 overlay the area of the display 16 in which the information of indicative of the function associated with key 14 is presented also provides the advantage that it is clear which information is associated with each key 14 and reduces the likelihood of a user inadvertently actuating the wrong key 14.

Although embodiments of the present invention have been described in the preceding paragraphs with reference to various examples, it should be appreciated that modifications to the examples given can be made without departing from the scope of the invention as claimed. For example in the illustrated embodiments both a first protective layer and a second protective layer are provided. In other embodiments only the first protective layer which overlays the display layer 34 may be needed.

In the illustrated embodiments the discontinuity 60 in the display layer 34 may be a gap comprising air or a filler material. In other embodiments of the invention the discontinuity 60 may comprise means for providing an output to a user. For example an illumination means may be provided in the discontinuity to enable the display 16 to be illuminated or to illuminate the user input portions 18. In other embodiments of the invention the discontinuity 60 may comprise an audio output device to enable an audio output to be provided to a user of the apparatus 10.

In other embodiments of the invention a lens may be provided in the discontinuity 60 to enable a camera to be used as a switch 40.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus comprising:
a display comprising a plurality of layers including a display layer and a first protective layer overlaying the display layer wherein the display layer comprises at least one discontinuity and the protective layer is continuous over the discontinuity in the display layer; and
a user input portion associated with the area of the first protective layer overlaying the discontinuity in the display layer and configured such that actuation of the user input portion enables a switch to be actuated.

2. An apparatus as claimed in claim 1 wherein the switch is located beneath the discontinuity in the display layer.

3. An apparatus as claimed in claim 1, wherein the display layer comprises a plurality of discontinuities and the first protective layer is continuous over the plurality of discontinuities in the display layer.

4. An apparatus as claimed in claim 1, wherein the user input portion is a key portion coupled to the first protective layer.

5. An apparatus as claimed in claim 1, wherein the first protective layer is configured to deform when the user input portion is actuated.

6. An apparatus as claimed in claim 1, comprising a second protective layer underneath the display layer wherein the second protective layer is continuous under the discontinuity in the display layer.

7. An apparatus as claimed in claim 6 comprising an actuating portion, associated with the area of the second protective layer underneath the discontinuities in the display layer, and configured to actuate a switch when the user input portion is actuated.

8. An apparatus as claimed in claim 6 wherein the second protective layer is configured to deform when the user input portion is actuated.

9. An apparatus as claimed in claim 1, wherein the first protective layer is transparent so that the display layer is visible through the first protective layer.

10. An apparatus as claimed in claim 1, wherein the display layer is configured to display information adjacent to the user input portion indicative of a function associated with the user input portion.

11. An apparatus as claimed in claim 10 wherein the orientation of the information displayed on the display depends upon the orientation of the apparatus.

12. An apparatus as claimed in claim 1, comprising a transparent layer overlaying the first protective layer wherein the transparent layer is rigid relative to the first protective layer and comprises discontinuities in the areas overlaying the user input portions.

13. An apparatus as claimed in claim 1, wherein the display layer comprises a plurality of layers including at least one electrode layer and an electronic ink layer.

14. A method comprising:
providing a display comprising a plurality of layers including a display layer and a first protective layer overlaying the display layer wherein the display layer comprises at least one discontinuity and the protective layer is continuous over the discontinuity in the display layer; and
providing a user input portion associated with the area of the first protective layer overlaying the discontinuity in the display layer and configured such that actuation of the user input portion enables a switch to be actuated.

15. A method as claimed in claim 14 wherein the switch is located beneath the discontinuity in the display layer.

16. A method as claimed in claim 14 wherein the display layer comprises a plurality of discontinuities and the first protective layer is continuous over the plurality of discontinuities in the display layer.

17. A method as claimed in claim 14 wherein the user input portion is a key portion coupled to the first protective layer.

18. A method as claimed in claim 14 wherein the first protective layer is configured to deform when the user input portion is actuated.

19. A method as claimed in claim 14 comprising providing a second protective layer underneath the display layer wherein the second protective layer is continuous under the discontinuity in the display layer.

20. A method as claimed in claim 19 comprising providing a portion, associated with the area of the second protective layer underneath the discontinuities in the display layer, and configured to actuate a switch when the user input portion is actuated.

21. A method as claimed in claim 19 wherein the second protective layer is deformed when the user input portion is actuated.

22. A method as claimed in claim 14 wherein the first protective layer is transparent so that the display layer is visible through the first protective layer.

23. A method as claimed in claim 14 wherein the display layer is configured to display information adjacent to the user input portion indicative of a function associated with the user input portion.

24. A method as claimed in claim 23 wherein the orientation of the information displayed on the display depends upon the orientation of the apparatus.

25. A method as claimed in claim 14 comprising providing a transparent layer overlaying the first protective layer wherein the transparent layer is rigid relative to the first protective layer and comprises discontinuities in the areas overlaying the user input portions.

26. A method as claimed in claim 14 wherein the display layer comprises a plurality of layers including at least one electrode layer and an electronic ink layer.
